(19) United States
(12) Patent Application Publication
(10) Pub. No.: US 2020/0004261 A1
(43) Pub. Date: Jan. 2, 2020

(54) AUTONOMOUS VEHICLE AND A CONTROL METHOD THEREOF

(71) Applicant: LG ELECTRONICS INC., Seoul (KR)

(72) Inventors: Cheol Seung KIM, Seoul (KR); Jun Young YU, Gimpo-si (KR); Soo Jung JEON, Uiwang-si (KR); Dae Geun HA, Seoul (KR)

(73) Assignee: LG ELECTRONICS INC., Seoul (KR)

(21) Appl. No.: 16/566,276

(22) Filed: Sep. 10, 2019

(30) Foreign Application Priority Data
Aug. 23, 2019 (KR) 10-2019-0103907

(51) Int. Cl. G05D 1/02; G05D 1/00; B60W 30/16; B60W 50/14; G01C 21/34; G07C 5/00

(52) U.S. Cl. CPC G05D 1/0223; G05D 1/0022; G07C 5/008; B60W 50/14; G01C 21/3492; B60W 30/16

(57) ABSTRACT

According to one embodiment of the present disclosure, an autonomous vehicle includes a loader which loads a service module, a driving unit which moves an autonomous vehicle, and a controller which controls the driving unit to perform at least one of acceleration driving, turning, and stopping of the autonomous vehicle, the controller checks a driving route of the autonomous vehicle and module information of a service module and controls the driving unit based on the driving route and the module information. At least one of the autonomous vehicle of the present disclosure may be linked to or integrated with an artificial intelligence module, a drone (an unmanned aerial vehicle, UAV), a robot, augmented reality (AR), virtual reality (VR), and a device related to 5G services.

### CROSS-REFERENCE TO RELATED APPLICATION

This present application claims benefit of priority to Korean Patent Application No. 10-2019-0103907, entitled “AUTONOMOUS VEHICLE AND A CONTROL METHOD THEREOF,” filed on Aug. 23, 2019, in the Korean Intellectual Property Office, the entire disclosure of which is incorporated herein by reference.

### BACKGROUND

### 1. Technical Field

The present disclosure relates to an autonomous vehicle and a control method thereof, and more particularly, to an autonomous vehicle loaded with a service module and a method for controlling a driving operation in consideration of the loaded service module.

### 2. Description of the Related Art

Various sensors and electronic apparatuses which assist a driver to control a driving operation are loaded in vehicles and as a representative example, there is an advanced driver assistance system (ADAS).

Further, an autonomous vehicle controls the driving operation by itself, communicates with a server to control the driving operation without intervention or manipulation of the driver or drives by itself with minimum intervention of the driver to provide convenience to the driver.

Specifically, a technology of controlling a mobile unit which enables control of acceleration or deceleration by sensing a position of a center of mass of a loaded object loaded in the mobile unit is disclosed in the related art 1.

In the related art 1, a technology of controlling an acceleration by a driving unit by sensing a position of a center of mass of a loaded object to prevent falling of the loaded object due to the acceleration has been disclosed, but there is a limitation in that a type of loaded object and a driving route are not considered and only accelerating or decelerating operation is controlled.

The above-described background technology is technical information that the inventors hold for the derivation of the present disclosure or that the inventors acquired in the process of deriving the present disclosure. Thus, the above-described background technology may not necessarily be regarded as known technology disclosed to the general public prior to the filing of the present application.

### RELATED ART DOCUMENT

### Patent Document

Related Art 1: Korean Registered Patent Publication No. 10-1941218 (registered on Jan. 16, 2019)

### SUMMARY OF THE INVENTION

An aspect of the present disclosure is to provide an autonomous vehicle and a method which controls a driving operation based on information of a service module and a driving route to prevent falling or collision of a service module when the autonomous vehicle loaded with a service module is driven.

An aspect of the present disclosure is to provide a method and an autonomous vehicle which control a driving operation to prevent the falling and collision of a service module by separating driving routes to be driven in different driving operations when the autonomous vehicle loaded with a service module performs a turning operation, an accelerating operation, or a decelerating operation.

An aspect of the present disclosure is to provide an autonomous vehicle which is controlled to be driven in consideration of module information of a service module to improve a driving stability and a control method thereof

An aspect of the present disclosure is to provide an autonomous vehicle which controls a driving operation based on a driving route of the autonomous vehicle to prevent the falling or collision of a service module to improve a driving stability and a control method thereof

The present disclosure is not limited to what has been described above, and other aspects and advantages of the present disclosure will be understood by the following description and become apparent from the embodiments of the present disclosure. Further, it is understood that the objects and advantages of the present disclosure may be embodied by the means and a combination thereof in the claims.

A control method of an autonomous vehicle according to one embodiment of the present disclosure controls a driving operation of a vehicle based on module information of a loaded service module and a driving route.

Specifically, according to one embodiment of the present disclosure, a control method of an autonomous vehicle includes checking module information of a loaded service module; checking a driving route; and controlling a driving operation of a vehicle based on the driving route and the module information.

According to the present disclosure, the control method of an autonomous vehicle controls the driving operation based on the module information and the driving route to improve a driving stability.

Further, the checking of module information may include receiving information related to at least one of a type, a size, and a weight of the service module from the service module or from a server based on a downlink grant, and in the controlling of a driving operation, the driving operation may be controlled based on at least one of the type, the size, and the weight of the service module and the driving route.

According to the present disclosure, the control method of an autonomous vehicle controls the driving operation based on the driving route and detailed contents of the module information so that the falling or the collision of the loaded service module may be prevented.

Further, the checking of module information may include checking a weight of the service module or a number of vibrations during driving through a sensor of a loader in which the service module is loaded and in the controlling of a driving operation, the driving operation may be controlled based the driving route and on any one of the weight of the service module or the number of vibrations during driving.

According to the present disclosure, the control method of an autonomous vehicle may prevent the falling due to the vibration of the loaded service module.

Further, the controlling of a driving operation may include controlling a maximum limit value of the driving speed or a driving acceleration of the driving speed to be lowered when a magnitude or variation of the number of vibrations exceeds a set criteria.

According to the present disclosure, the control method of an autonomous vehicle may specifically control the driving operation in accordance with a vibration level of the loaded service module.

Further, the controlling of a driving operation may include controlling the driving operation based on a possibility of a fall of the service module and controlling the driving operation to perform turning in different curved sections of a curved route at different angular velocities when the turning is necessary for the curved route of the driving route.

According to the present disclosure, the control method of an autonomous vehicle may control the driving operation to prevent the falling of the service module due to the turning operation of the loaded service module.

After the controlling of a driving operation, the control method of an autonomous vehicle may further include transmitting a warning message to surrounding vehicles to prevent the surrounding vehicles from entering a turning route.

According to the present disclosure, the control method of an autonomous vehicle allows the surrounding vehicles to predict the driving operation of the autonomous vehicle, thereby improving a driving stability.

Further, the controlling of a driving operation may include controlling a driving operation by driving in different sections of the driving route at different accelerations to reach a target speed if deceleration driving or acceleration driving is necessary in the driving route and include controlling a driving operation by driving in different sections of the driving route alternately at acceleration and at a constant velocity to reach the target speed.

According to the present disclosure, the control method of an autonomous vehicle may control the driving operation to prevent the falling of the service module due to the decelerating operation or the accelerating operation of the loaded service module.

The control method of an autonomous vehicle may further include transmitting a module movement command to the service module to prevent falling or collision of the service module based on a driving operation expected in accordance with the driving route.

According to the present disclosure, the control method of an autonomous vehicle may control the driving operation to prevent the falling of the service module by moving the service module in a loading space of the loaded service module.

Further, the controlling of a driving operation may include controlling the driving operation further based on the type of service article provided by the service module and the control method of an autonomous vehicle may further include requesting a client vehicle to change a route or a speed in order to deliver a service article to the client vehicle.

According to the present disclosure, the control method of an autonomous vehicle may allow the service articles provided by the service module to be safely delivered to a client vehicle which is driving or parked.

According to an aspect of the present disclosure, an autonomous vehicle may control a driving unit for a driving operation for at least one of acceleration driving, turning, and stopping based on a driving route and module information.

Specifically, according to one embodiment of the present disclosure, an autonomous vehicle includes a loader which loads a service module; a driving unit which moves an autonomous vehicle; and a controller which controls the driving unit to perform at least one of acceleration driving, turning, and stopping of the autonomous vehicle, and the controller checks the driving route of the autonomous vehicle and module information of the service module and controls the driving unit based on the driving route and the module information.

According to the present disclosure, the control method of an autonomous vehicle controls the driving operation based on the module information and the driving route to improve a driving stability.

Further, the autonomous vehicle may further include a communicator which transmits/receives information with the service module or transmits/receives information with a server device based on a configured grant, the controller may receive module information including information related to at least one of the type, the size, and the weight of the service module through the communicator and the controller may control the driving unit based on at least one of the type, the size, and the weight of the service module and the driving route.

The autonomous vehicle may further include a sensor which is mounted in the loader to sense the weight of the service module or the number of vibrations during driving and the controller may control the driving unit based on at least one of the weight of the service module and the number of vibrations during driving and the driving route.

Further, the autonomous vehicle may further include a communicator which transmits/receives information with the service module and the controller calculates, based on a driving operation expected in accordance with the driving route, a position of the service module for preventing the falling or collision of the service module, and the communicator transmits a movement command to the service module to move to the position of the service module.

According to the present disclosure, the autonomous vehicle may move the service module in a loading space of the loaded service module to prevent the falling of the service module.

Further, when the deceleration driving or the acceleration driving is necessary, the controller may control to alternately drive at different accelerations to reach a target speed, the autonomous vehicle may further include a distance sensor which measures a distance from a preceding vehicle, and the controller may determine the number of changes of acceleration and the magnitude of the acceleration based on the distance from the preceding vehicle.

According to the present disclosure, the autonomous vehicle may control the driving operation to prevent the falling of the service module due to the decelerating operation or the accelerating operation of the loaded service module.

According to the present disclosure, the driving operation is controlled based on various situations such as a type and a weight of the service module loaded in the autonomous vehicle and a state during driving and driving routes to improve a driving stability.

Further, the driving operation is controlled based on module information of the service module and a driving route to prevent the falling or collision of the loaded service module while the autonomous vehicle is driving.

Furthermore, the driving operation is controlled based on various driving operations such as the turning, the acceleration driving, or the deceleration driving of the autonomous vehicle to prevent the falling or collision of the loaded service module while the autonomous vehicle is driving.

The effects of the present disclosure are not limited to those mentioned above, and other effects not mentioned can be clearly understood by those skilled in the art from the following description.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a diagram illustrating an example of the basic operation of an autonomous vehicle and a 5G network in a 5G communication system;

FIG. 2 is a diagram illustrating an example of an applied operation of an autonomous vehicle and a 5G network in a 5G communication system;

FIGS. 3 to 6 are diagrams illustrating an example of the operation of an autonomous vehicle using a 5G communication;

FIG. 7 is a diagram illustrating an example of an AI device including an autonomous vehicle;

FIG. 8 is a diagram illustrating an example of an AI server which is communicable with an autonomous vehicle;

FIG. 9 is a diagram illustrating an example of an AI system to which an AI device including an autonomous vehicle is connected;

FIG. 10 is an exemplary diagram of an autonomous vehicle loaded with a service module according to one embodiment of the present disclosure and a driving operation control environment;

FIG. 11 is a block diagram illustrating a configuration of an autonomous vehicle according to one embodiment of the present disclosure;

FIG. 12 is a flowchart for explaining an operation of an autonomous vehicle according to one embodiment of the present disclosure; and

FIGS. 13 to 17 are exemplary diagrams for explaining driving operation control of an autonomous vehicle according to one embodiment of the present disclosure.

### DETAILED DESCRIPTION

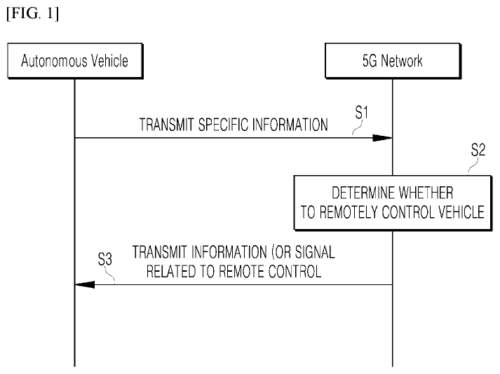

FIG. 1 is a diagram illustrating an example of the basic operation of an autonomous vehicle and a 5G network in a 5G communication system.

An autonomous vehicle transmits specific information to a 5G network (S1).

The specific information may include autonomous driving related information.

The autonomous driving related information may be information directly related to the running control of the vehicle. For example, the autonomous driving related information may include at least one of object data indicating An aspect around the vehicle, map data, vehicle state data, vehicle position data, and driving plan data.

The autonomous driving related information may further include service information necessary for autonomous driving. For example, the specific information may include information about the destination and the stability level of the vehicle, which are inputted through a user terminal. In addition, the 5G network may determine whether the vehicle is remotely controlled (S2).

Here, the 5G network may include a server or a module that performs autonomous driving related remote control.

The 5G network may transmit information (or signals) related to the remote control to the autonomous vehicle (S3).

As described above, the information related to the remote control may be a signal directly applied to the autonomous vehicle, and may further include service information required for autonomous driving. In one embodiment of the present disclosure, the autonomous vehicle can provide autonomous driving related services by receiving service information such as insurance and danger sector information selected on a route through a server connected to the 5G network.

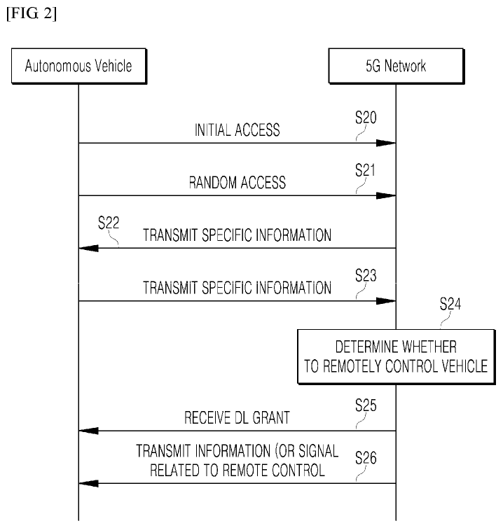

Hereinafter, FIGS. 2 to 6 schematically illustrate an essential process for 5G communication between an autonomous vehicle and a 5G network (for example, an initial access procedure between the vehicle and the 5G network, etc.) in order to provide the applicable insurable service by sections in the autonomous driving process according to one embodiment of the present disclosure.

FIG. 2 is a diagram illustrating an example of an applied operation of an autonomous vehicle and a 5G network in a 5G communication system.

The autonomous vehicle performs an initial access procedure with the 5G network (S20).

The initial access procedure includes a process of acquiring a cell AI server device 200 (cell search) and system information for downlink (DL) operation acquisition.

In addition, the autonomous vehicle performs a random access procedure with the 5G network (S21).

The random access process may include a process for uplink (UL) synchronization acquisition or a preamble transmission process for UL data transmission, or a random access response receiving process, which will be described in detail in the paragraph G.

The 5G network transmits an UL grant for scheduling transmission of specific information to the autonomous vehicle (S22).

The UL grant reception includes a scheduling process of time/frequency resource for transmission of the UL data over the 5G network.

In addition, the autonomous vehicle transmits specific information to the 5G network based on the UL grant (S23).

In addition, the 5G network determines whether the vehicle is to be remotely controlled (S24).

In addition, the autonomous vehicle receives the DL grant through a physical downlink control channel for receiving a response on specific information from the 5G network (S25).

In addition, the 5G network may transmit information (or a signal) related to the remote control to the autonomous vehicle based on the DL grant (S26).

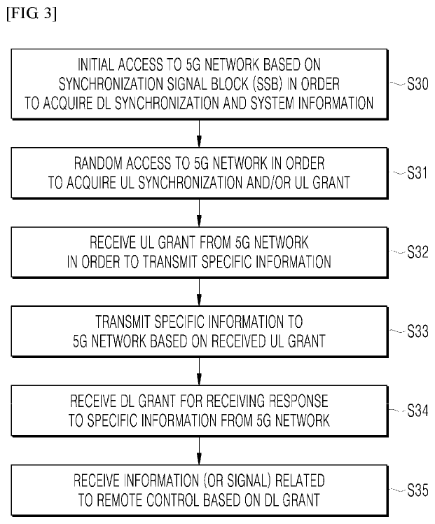

In the meantime, although in FIG. 3, an example in which the initial access process or the random access process of the autonomous vehicle and 5G communication and the downlink grant reception process are combined has been exemplarily described through the steps S20 to S26, the present disclosure is not limited thereto.

For example, the initial access process and/or the random access process may be performed through S20, S22, S23, S24, and S25. Further, for example, the initial access process and/or the random access process may be performed through S21, S22, S23, S24, and S26. Further, a process of combining the AI operation and the downlink grant receiving process may be performed through S23, S24, S25, and S26.

Further, in FIG. 2, the operation of the autonomous vehicle has been exemplarily described through S20 to S26, but the present disclosure is not limited thereto.

For example, the operation of the autonomous vehicle may be performed by selectively combining the steps S20, S21, S22, and S25 with the steps S23 and S26. Further, for example, the operation of the autonomous vehicle may be configured by the steps S21, S22, S23, and S26. Further, for example, the operation of the autonomous vehicle may be configured by the steps S20, S21, S23, and S26. Further, for example, the operation of the autonomous vehicle may be configured by the steps S22, S23, S25, and S26.

FIGS. 3 to 6 illustrate an example of an operation of an autonomous vehicle using 5G communication.

First, referring to FIG. 3, the autonomous vehicle including an autonomous driving module performs an initial access procedure with a 5G network based on a synchronization signal block (SSB) in order to acquire DL synchronization and system information (S30).

In addition, the autonomous vehicle performs a random access procedure with the 5G network for UL synchronization acquisition and/or UL transmission (S31).

In addition, the autonomous vehicle receives the UL grant from the 5G network to transmit specific information (S32).

In addition, the autonomous vehicle transmits the specific information to the 5G network based on the UL grant (S33).

In addition, the autonomous vehicle receives the DL grant from the 5G network to receive a response to the specific information (S34).

In addition, the autonomous vehicle receives remote control related information (or a signal) from the 5G network based on the DL grant (S35)

Beam Management (BM) may be added to step S30, a beam failure recovery process associated with Physical Random Access Channel (PRACH) transmission may be added to step S31, a QCL (Quasi Co-Located) relation may be added to step S32 with respect to a beam receiving direction of a Physical Downlink Control Channel (PDCCH) including an UL grant, and a QCL relation may be added to step S33 with respect to the beam transmission direction of the Physical Uplink Control Channel (PUCCH)/Physical Uplink Shared Channel (PUSCH) including specific information. Further, the QCL relation may be added to step S34 with respect to the beam receiving direction of PDCCH including a DL grant.

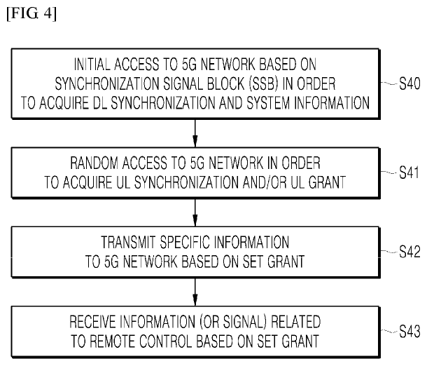

Referring to FIG. 4, the autonomous vehicle performs an initial access procedure with the 5G network based on the SSB in order to obtain DL synchronization and system information (S40).

In addition, the autonomous vehicle performs a random access procedure with the 5G network for UL synchronization acquisition and/or UL transmission (S41).

In addition, the autonomous vehicle transmits the specific information to the 5G network based on a configured grant (S42). A process of transmitting the configured grant, instead of the process of receiving the UL grant from the 5G network, will be described in more detail in the paragraph H.

In addition, the autonomous vehicle receives remote control related information (or signal) from the 5G network based on the configured grant (S43).

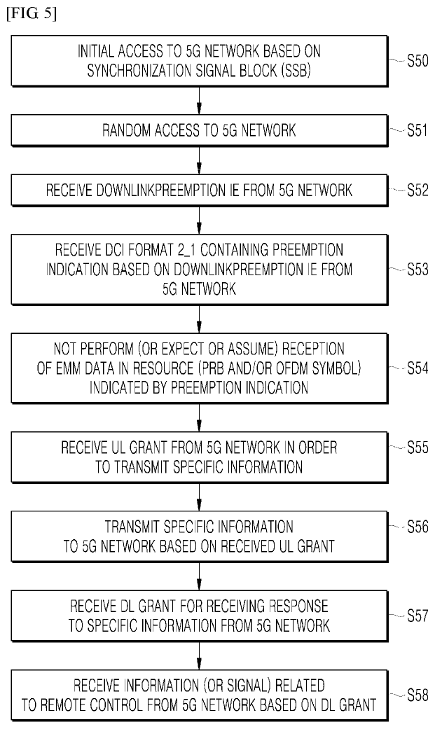

Referring to FIG. 5, the autonomous vehicle performs the initial access procedure with the 5G network based on the SSB in order to acquire the DL synchronization and system information (S50).

In addition, the autonomous vehicle performs a random access procedure with the 5G network for UL synchronization acquisition and/or UL transmission (S51).

In addition, the autonomous vehicle receives DownlinkPreemption IE from the 5G network (S52).

In addition, the autonomous vehicle receives a DCI (Downlink Control Information) format 2_1 including pre-emption indication based on the DL preemption IE from the 5G network (S53).

In addition, the autonomous vehicle does not perform (or expect or assume) the reception of eMBB data in the resource (PRB and/or OFDM symbol) indicated by the pre-emption indication (S54).

The pre-emption indication related operation will be described in more detail in the paragraph J.

In addition, the autonomous vehicle receives the UL grant from the 5G network to transmit the specific information (S55).

In addition, the autonomous vehicle transmits the specific information to the 5G network based on the UL grant (S56).

In addition, the autonomous vehicle receives the DL grant from the 5G network to receive a response to the specific information (S57).

In addition, the autonomous vehicle receives the remote control related information (or signal) from the 5G network based on the DL grant (S58).

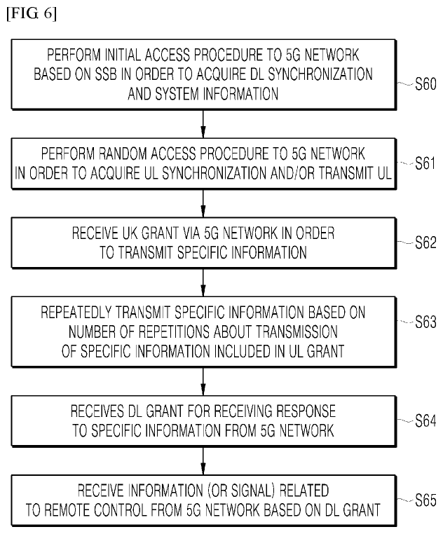

Referring to FIG. 6, the autonomous vehicle performs the initial access procedure with the 5G network based on the SSB in order to acquire the DL synchronization and system information (S60).

In addition, the autonomous vehicle performs a random access procedure with the 5G network for UL synchronization acquisition and/or UL transmission (S61).

In addition, the autonomous vehicle receives the UL grant from the 5G network in order to transmit specific information (S62).

The UL grant includes information on the number of repetitions for transmission of the specific information, and the specific information may be repeatedly transmitted based on information on the number of repetitions (S63).

In addition, the autonomous vehicle transmits the specific information to the 5G network based on the UL grant.

Also, the repetitive transmission of specific information may be performed through frequency hopping, the first specific information may be transmitted in the first frequency resource, and the second specific information may be transmitted in the second frequency resource.

The specific information may be transmitted through Narrowband of Resource Block (6 RB) and Resource Block (1 RB).

In addition, the autonomous vehicle receives the DL grant from the 5G network in order to receive a response to the specific information (S64).

In addition, the autonomous vehicle receives the remote control related information (or signal) from the 5G network based on the DL grant (S65).

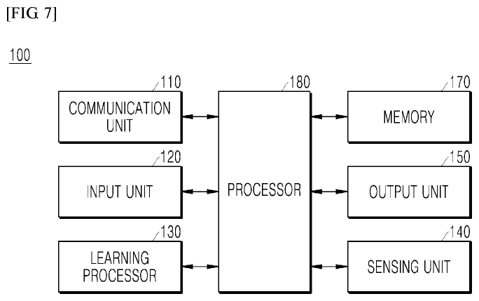

The above-described 5G communication technique can be applied in combination with the methods proposed in this specification, which will be described in FIG. 7 to FIG. 17, or supplemented to specify or clarify the technical feature of the methods proposed in this specification.

The vehicle described herein is connected to an external server through a communication network, and is capable of moving along a predetermined route without driver intervention using the autonomous driving technology. The vehicle described herein may include, but is not limited to, a vehicle having an internal combustion engine as a power source, a hybrid vehicle having an engine and an electric motor as a power source, and an electric vehicle having an electric motor as a power source.

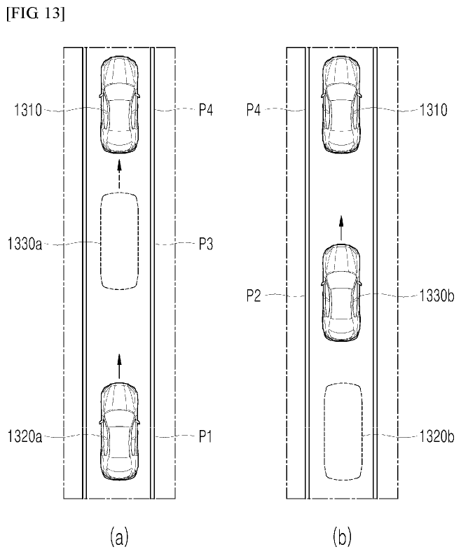

In the following embodiments, the user may be interpreted as a driver, a passenger, or the owner of a user terminal. The user terminal may be a mobile terminal which is carried by the user and executes various applications as well as the phone call, for example, a smart phone, but is not limited thereto. For example, the user terminal may be interpreted as a mobile terminal, a personal computer, a notebook computer, or an autonomous vehicle system as illustrated in FIG. 13.

While the vehicle is driving in the autonomous driving mode, the type and frequency of accident occurrence may depend on the capability of the vehicle of sensing dangerous elements in the vicinity in real time. The route to the destination may include sections having different levels of risk due to various causes such as weather, terrain characteristics, traffic congestion, and the like. According to the present disclosure, when the user inputs a destination, an insurance required for every sector is guided and a danger sector is monitored in real time to update the insurance guide.

At least one of the autonomous vehicle, the user terminal, or the server of the present disclosure may be linked to or integrated with an artificial intelligence module, a drone (an unmanned aerial vehicle, UAV), a robot, an augmented reality (AR), a virtual reality (VR), and a device related to 5G services.

Autonomous driving refers to a technology in which driving is performed autonomously, and an autonomous vehicle refers to a vehicle capable of driving without manipulation of a user or with minimal manipulation of a user.

For example, autonomous driving may include a technology in which a driving lane is maintained, a technology such as adaptive cruise control in which a speed is automatically adjusted, a technology in which a vehicle automatically drives along a defined route, and a technology in which a route is automatically set when a destination is set.

A vehicle includes a vehicle having only an internal combustion engine, a hybrid vehicle having both an internal combustion engine and an electric motor, and an electric vehicle having only an electric motor, and may include not only an automobile but also a train and a motorcycle.

In this case, an autonomous vehicle may be considered as a robot with an autonomous driving function.

Artificial intelligence refers to a field of studying artificial intelligence or a methodology for creating the same.

Moreover, machine learning refers to a field of defining various problems dealing in an artificial intelligence field and studying methodologies for solving the same. In addition, machine learning may be defined as an algorithm for improving performance with respect to a task through repeated experience with respect to the task.

An artificial neural network (ANN) is a model used in machine learning, and may refer in general to a model with problem-solving abilities, composed of artificial neurons (nodes) forming a network by a connection of synapses. The ANN may be defined by a connection pattern between neurons on different layers, a learning process for updating a model parameter, and an activation function for generating an output value.

The ANN may include an input layer, an output layer, and may selectively include one or more hidden layers. Each layer includes one or more neurons, and the artificial neural network may include synapses that connect the neurons to one another. In an ANN, each neuron may output a function value of an activation function with respect to the input signals inputted through a synapse, weight, and bias.

A model parameter refers to a parameter determined through learning, and may include weight of synapse connection, bias of a neuron, and the like. Moreover, a hyperparameter refers to a parameter which is set before learning in a machine learning algorithm, and includes a learning rate, a number of repetitions, a mini batch size, an initialization function, and the like.

The objective of training an ANN is to determine a model parameter for significantly reducing a loss function. The loss function may be used as an indicator for determining an optimal model parameter in a learning process of an artificial neural network.

The machine learning may be classified into supervised learning, unsupervised learning, and reinforcement learning depending on the learning method.

Supervised learning may refer to a method for training an artificial neural network with training data that has been given a label. In addition, the label may refer to a target answer (or a result value) to be guessed by the artificial neural network when the training data is inputted to the artificial neural network. Unsupervised learning may refer to a method for training an artificial neural network using training data that has not been given a label. Reinforcement learning may refer to a learning method for training an agent defined within an environment to select an action or an action order for maximizing cumulative rewards in each state.

Machine learning of an artificial neural network implemented as a deep neural network (DNN) including a plurality of hidden layers may be referred to as deep learning, and the deep learning is one machine learning technique. Hereinafter, the meaning of machine learning includes deep learning.

For example, the autonomous vehicle may operate in association with at least one artificial intelligence module or robot included in the vehicle in the autonomous driving mode.

A robot may refer to a machine which automatically handles a given task by its own ability, or which operates autonomously. In particular, a robot having a function of recognizing an environment and performing an operation according to its own judgment may be referred to as an intelligent robot.

Robots may be classified into industrial, medical, household, and military robots, according to the purpose or field of use.

A robot may include an actuator or a driving unit including a motor in order to perform various physical operations, such as moving joints of the robot. Moreover, a movable robot may include, for example, a wheel, a brake, and a propeller in the driving unit thereof, and through the driving unit may thus be capable of traveling on the ground or flying in the air.

For example, the autonomous vehicle may interact with at least one robot. The robot may be an autonomous mobile robot (AMR). Being capable of driving by itself, the AMR may freely move, and may include a plurality of sensors so as to avoid obstacles during traveling. The AMR may be a flying robot (such as a drone) equipped with a flight device. The AMR may be a wheel-type robot equipped with at least one wheel, and which is moved through the rotation of the at least one wheel. The AMR may be a leg-type robot equipped with at least one leg, and which is moved using the at least one leg.

The robot may function as a device that enhances the convenience of a user of a vehicle. For example, the robot may move a load placed in the vehicle to a final destination. For example, the robot may perform a function of providing route guidance to a final destination to a user who alights from the vehicle. For example, the robot may perform a function of transporting the user who alights from the vehicle to the final destination

At least one electronic apparatus included in the vehicle may communicate with the robot through a communication device.

At least one electronic apparatus included in the vehicle may provide, to the robot, data processed by the at least one electronic apparatus included in the vehicle. For example, at least one electronic apparatus included in the vehicle may provide, to the robot, at least one among object data indicating An aspect near the vehicle, map data, vehicle status data, vehicle position data, and driving plan data.

At least one electronic apparatus included in the vehicle may receive, from the robot, data processed by the robot. At least one electronic apparatus included in the vehicle may receive at least one among sensing data sensed by the robot, object data, robot status data, robot location data, and robot movement plan data.

At least one electronic apparatus included in the vehicle may generate a control signal based on data received from the robot. For example, at least one electronic apparatus included in the vehicle may compare the information about the object generated by the object detector with the information about the object generated by the robot, and generate a control signal based on the comparison result. At least one electronic apparatus included in the vehicle may generate a control signal so that interference between the vehicle movement route and the robot movement route may not occur.

At least one electronic apparatus included in the vehicle may include a software module or a hardware module for implementing an artificial intelligence (AI) (hereinafter referred to as an artificial intelligence module). At least one electronic device included in the vehicle may input the acquired data to the AI module, and use the data which is outputted from the AI module.

The artificial intelligence module may perform machine learning of input data by using at least one artificial neural network (ANN). The artificial intelligence module may output driving plan data through machine learning of input data.

At least one electronic apparatus included in the vehicle may generate a control signal based on the data processed by the artificial intelligence.

According to the embodiment, at least one electronic apparatus included in the vehicle may receive data processed by an artificial intelligence from an external device through a communication device. At least one electronic apparatus included in the vehicle 1000 may generate a control signal based on data processed by artificial intelligence.

FIG. 7 is a view illustrating an external appearance of an AI device 100 according to one embodiment of the present disclosure.

The AI device 100 may be implemented by a fixed device or a mobile device such as a TV, a projector, a mobile phone, a smart phone, a desktop computer, a notebook, a digital broadcasting terminal, a personal digital assistance (PDA), a portable multimedia player (PMP), a navigation, a tablet PC, a wearable device, a set-top box (STB), a DMB receiver, a radio, a washing machine, a refrigerator, a desktop computer, a digital signage, a robot, or a vehicle.

Referring to FIG. 7, the terminal 100 includes a communicator 110, an inputter 120, a learning processor 130, a sensor 140, an outputter 150, a memory 170, and a processor 180.

The communicator 110 may transmit or receive data with external devices such as other AI devices 100a to 100e or an AI server 200 using a wired/wireless communication technology. For example, the communicator 110 may transmit or receive sensor data, user input, a learning model, a control signal, and the like with the external devices.

In this case, the communications technology used by the communicator 110 may be technology such as global system for mobile communication (GSM), code division multi access (CDMA), long term evolution (LTE), 5G, wireless LAN (WLAN), Wireless-Fidelity (Wi-Fi), Bluetooth™, radio frequency identification (RFID), infrared data association (IrDA), ZigBee, and near field communication (NFC).

The inputter 120 may obtain various types of data.

In this case, the inputter 120 may include a camera for inputting an image signal, a microphone for receiving an audio signal, and a user inputter for receiving information inputted from a user. Here, the camera or the microphone is treated as a sensor so that a signal obtained from the camera or the microphone may also be referred to as sensing data or sensor information.

The inputter 120 may obtain, for example, learning data for model learning and input data used when output is obtained using a learning model. The inputter 120 may obtain raw input data.

In this case, the processor 180 or the learning processor 130 may extract an input feature by preprocessing the input data.

The learning processor 130 may allow a model, composed of an artificial neural network to be trained using learning data. Here, the trained artificial neural network may be referred to as a trained model. The trained model may be used to infer a result value with respect to new input data rather than learning data, and the inferred value may be used as a basis for a determination to perform an operation of classifying the detected hand motion.

The learning processor 130 may perform AI processing together with a learning processor 240 of the AI server 200.

The learning processor 130 may include a memory which is combined or implemented in the AI device 100. Alternatively, the learning processor 130 may be implemented using the memory 170, an external memory directly coupled to the AI device 100, or a memory maintained in an external device.

The sensor 140 may obtain at least one of internal information of the AI device 100, surrounding environment information of the AI device 100, or user information by using various sensors.

The sensor 140 may include a proximity sensor, an illumination sensor, an acceleration sensor, a magnetic sensor, a gyroscope sensor, an inertial sensor, an RGB sensor, an infrared (IR) sensor, a finger scan sensor, an ultrasonic sensor, an optical sensor, a microphone, a light detection and ranging (LiDAR) sensor, radar, or a combination thereof

The outputter 150 may generate a visual, auditory, or tactile related output.

The outputter 150 may include a display outputting visual information, a speaker outputting auditory information, and a haptic module outputting tactile information.

The memory 170 may store data supporting various functions of the AI device 100.

The processor 180 may determine at least one executable operation of the AI device 100 based on information determined or generated by using a data analysis algorithm or a machine learning algorithm. In addition, the processor 180 may control components of the AI device 100 to perform the determined operation.

To this end, the processor 180 may request, retrieve, receive, or use data of the learning processor 130 or the memory 170, and may control components of the apparatus 100 to execute a predicted operation or an operation determined to be preferable of the at least one executable operation.

In this case, when it is required to be linked with the external device to perform the determined operation, the processor 180 generates a control signal for controlling the corresponding external device and transmits the generated control signal to the corresponding external device.

The processor 180 obtains intent information about user input, and may determine a requirement of a user based on the obtained intent information.

In this case, the processor 180 may obtain the intent information corresponding to the user input using at least one of a speech to text (STT) engine for converting a speech input into text strings or a natural language processing (NLP) engine for obtaining intent information of the natural language.

In an embodiment, the at least one of the STT engine or the NLP engine may be composed of artificial neural networks, some of which are trained according to a machine learning algorithm. In addition, the at least one of the STT engine or the NLP engine may be trained by the learning processor 130, trained by a learning processor 240 of an AI server 200, or trained by distributed processing thereof

The processor 180 collects history information including, for example, operation contents and user feedback on an operation of the AI device 100, and stores the history information in the memory 170 or the learning processor 130, or transmits the history information to an external device such as an AI server 200. The collected history information may be used to update a learning model.

The processor 180 may control at least some of components of the AI device 100 to drive an application stored in the memory 170. Furthermore, the processor 180 may operate two or more components included in the AI device 100 in combination with each other to drive the application.

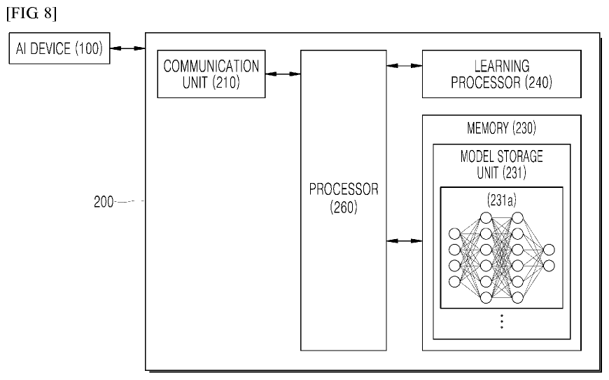

FIG. 8 is a view illustrating an AI server 200 according to one embodiment of the present disclosure.

Referring to FIG. 8, the AI server 200 may refer to a device for training an artificial neural network using a machine learning algorithm or using a trained artificial neural network. Here, the AI server 200 may include a plurality of servers to perform distributed processing, and may be defined as a 5G network. In this case, the AI server 200 may be included as a configuration of a portion of the AI device 100, and may thus perform at least a portion of the AI processing together.

The AI server 200 may include a communicator 210, a memory 230, a learning processor 240, and a processor 260.

The communicator 210 may transmit and receive data with an external device such as the AI device 100.

The memory 230 may include a model storage 231. The model storage 231 may store a model (or an artificial neural network 231a) learning or learned via the learning processor 240.

The learning processor 240 may train the artificial neural network 231a by using learning data. The learning model may be used while mounted in the AI server 200 of the artificial neural network, or may be used while mounted in an external device such as the AI device 100.

The learning model may be implemented as hardware, software, or a combination of hardware and software. When a portion or the entirety of the learning model is implemented as software, one or more instructions, which constitute the learning model, may be stored in the memory 230.

The processor 260 may infer a result value with respect to new input data by using the learning model, and generate a response or control command based on the inferred result value.

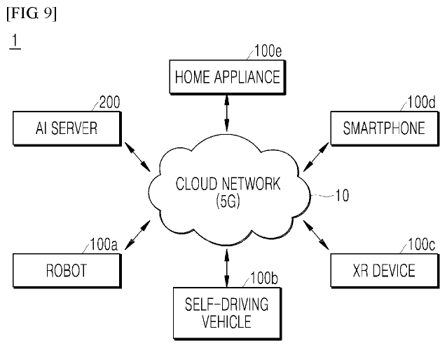

FIG. 9 is a block diagram illustrating a configuration of an AI system 1 according to one embodiment of the present disclosure.

Referring to FIG. 9, in the AI system 1, at least one or more of AI server 200, robot 100a, autonomous vehicle 100b, XR device 100c, smartphone 100d, or home appliance 100e are connected to a cloud network 10. Here, the robot 100a, autonomous vehicle 100b, XR device 100c, smartphone 100d, or home appliance 100e to which the AI technology has been applied may be referred to as an AI device (100a to 100e).

The cloud network 10 may include part of the cloud computing infrastructure or refer to a network existing in the cloud computing infrastructure. Here, the cloud network 10 may be constructed by using the 3G network, 4G or Long Term Evolution (LTE) network, or 5G network.

In other words, individual devices (100a to 100e, 200) constituting the AI system 1 may be connected to each other through the cloud network 10. In particular, each individual device (100a to 100e, 200) may communicate with each other through the base station but may communicate directly to each other without relying on the base station.

The AI server 200 may include a server performing AI processing and a server performing computations on big data.

The AI server 200 may be connected to at least one or more of the robot 100a, autonomous vehicle 100b, XR device 100c, smartphone 100d, or home appliance 100e, which are AI devices constituting the AI system, through the cloud network 10 and may help at least part of AI processing conducted in the connected AI devices (100a to 100e).

At this time, the AI server 200 may train the artificial neural network according to a machine learning algorithm on behalf of the AI devices (100a to 100e), directly store the learning model, or transmit the learning model to the AI devices (100a to 100e).

At this time, the AI server 200 may receive input data from the AI device 100a to 100e, infer a result value from the received input data by using the learning model, generate a response or control command based on the inferred result value, and transmit the generated response or control command to the AI device 100a to 100e.

Similarly, the AI device 100a to 100e may infer a result value from the input data by employing the learning model directly and generate a response or control command based on the inferred result value.

Hereinafter, various embodiments of the AI devices 100a to 100e to which the above-described technique is applied will be described. Here, the AI devices 100a to 100e illustrated in FIG. 3 may be considered as a specific embodiment of the AI device 100 illustrated in FIG. 1.

By employing the AI technology, the robot 100a may be implemented as a guide robot, transport robot, cleaning robot, wearable robot, entertainment robot, pet robot, or unmanned flying robot.

The robot 100a may include a robot control module for controlling its motion, where the robot control module may correspond to a software module or a chip which implements the software module in the form of a hardware device.

The robot 100a may obtain status information of the robot 100a, detect (recognize) the surroundings and objects, generate map data, determine a travel path and navigation plan, determine a response to user interaction, or determine motion by using sensor information obtained from various types of sensors.

Here, the robot 100a may use sensor information obtained from at least one or more sensors among lidar, radar, and camera to determine a travel path and navigation plan.

The robot 100a may perform the operations above by using a learning model built on at least one or more artificial neural networks. For example, the robot 100a may recognize the surroundings and objects by using the learning model and determine its motion by using the recognized surroundings or object information. Here, the learning model may be the one trained by the robot 100a itself or trained by an external device such as the AI server 200.

At this time, the robot 100a may perform the operation by generating a result by employing the learning model directly but also perform the operation by transmitting sensor information to an external device such as the AI server 200 and receiving a result generated accordingly.

The robot 100a may determine a travel path and navigation plan by using at least one or more of object information detected from the map data and sensor information or object information obtained from an external device and navigate according to the determined travel path and navigation plan by controlling its locomotion platform.

Map data may include object identification information about various objects disposed in the space in which the robot 100a navigates. For example, the map data may include object identification information about static objects such as wall and doors and movable objects such as a flowerpot and a desk. In addition, the object identification information may include the name, type, distance, location, and so on.

Also, the robot 100a may perform the operation or navigate the space by controlling its locomotion platform based on the control/interaction of the user. At this time, the robot 100a may obtain intention information of the interaction due to the user's motion or voice command and perform an operation by determining a response based on the obtained intention information.

By employing the AI technology, the autonomous vehicle 100b may be implemented as a mobile robot, unmanned ground vehicle, or unmanned aerial vehicle.

The autonomous vehicle 100b may include an autonomous navigation module for controlling its autonomous navigation function, where the autonomous navigation control module may correspond to a software module or a chip which implements the software module in the form of a hardware device. The autonomous navigation control module may be installed inside the autonomous vehicle 100b as a constituting element thereof or may be installed outside the autonomous vehicle 100b as a separate hardware component.

The autonomous vehicle 100b may obtain status information of the autonomous vehicle 100b, detect (recognize) the surroundings and objects, generate map data, determine a travel path and navigation plan, or determine motion by using sensor information obtained from various types of sensors.

Like the robot 100a, the autonomous vehicle 100b may use sensor information obtained from at least one or more sensors among lidar, radar, and camera to determine a travel path and navigation plan.

In particular, the autonomous vehicle 100b may recognize an occluded area or an area extending over a predetermined distance or objects located across the area by collecting sensor information from external devices or receive recognized information directly from the external devices.

The autonomous vehicle 100b may perform the operations above by using a learning model built on at least one or more artificial neural networks. For example, the autonomous vehicle 100b may recognize the surroundings and objects by using the learning model and determine its navigation route by using the recognized surroundings or object information. Here, the learning model may be the one trained by the autonomous vehicle 100b itself or trained by an external device such as the AI server 200.

At this time, the autonomous vehicle 100b may perform the operation by generating a result by employing the learning model directly but also perform the operation by transmitting sensor information to an external device such as the AI server 200 and receiving a result generated accordingly.

The autonomous vehicle 100b may determine a travel path and navigation plan by using at least one or more of object information detected from the map data and sensor information or object information obtained from an external device and navigate according to the determined travel path and navigation plan by controlling its driving platform.

Map data may include object identification information about various objects disposed in the space (for example, road) in which the autonomous vehicle 100b navigates. For example, the map data may include object identification information about static objects such as streetlights, rocks and buildings and movable objects such as vehicles and pedestrians. In addition, the object identification information may include the name, type, distance, location, and so on.

Also, the autonomous vehicle 100b may perform the operation or navigate the space by controlling its driving platform based on the control/interaction of the user. At this time, the autonomous vehicle 100b may obtain intention information of the interaction due to the user's motion or voice command and perform an operation by determining a response based on the obtained intention information.

By employing the AI and autonomous navigation technologies, the robot 100a may be implemented as a guide robot, transport robot, cleaning robot, wearable robot, entertainment robot, pet robot, or unmanned flying robot.

The robot 100a employing the AI and autonomous navigation technologies may correspond to a robot itself having an autonomous navigation function or a robot 100a interacting with the autonomous navigation function or a robot 100a interacting with the autonomous vehicle 100b.

The robot 100a having the autonomous navigation function may correspond collectively to the devices which may move autonomously along a given path without control of the user or which may move by determining its path autonomously.

The robot 100a and the autonomous vehicle 100b having the autonomous navigation function may use a common sensing method to determine one or more of the travel path or navigation plan. For example, the robot 100a and the autonomous vehicle 100b having the autonomous navigation function may determine one or more of the travel path or navigation plan by using the information sensed through lidar, radar, and camera.

The robot 100a interacting with the autonomous vehicle 100b exists separately from the autonomous vehicle 100b to be connected to the autonomous navigation function inside or outside the autonomous vehicle 100b or perform an operation connected with the user on the autonomous vehicle 100b.

In this case, the robot 100a interacting with the autonomous vehicle 100b obtains sensor information on behalf of the autonomous vehicle to provide the sensor information to the autonomous vehicle 100b or obtains sensor information and generates surrounding environment information or object information to provide the information to the autonomous vehicle 100b, to control or assist the autonomous navigation function of the autonomous vehicle 100b.

In addition, the robot 100a interacting with the autonomous vehicle 100b monitors a user on the autonomous vehicle 100b or interacts with the user to control the function of the autonomous vehicle 100b. For example, if it is determined that the driver is drowsy, the robot 100a may activate the autonomous navigation function of the autonomous vehicle 100b or assist the control of the driving platform of the autonomous vehicle 100b. Here, the function of the autonomous vehicle 100b controlled by the robot 100a may include not only the autonomous navigation function but also the navigation system installed inside the autonomous vehicle 100b or the function provided by the audio system of the autonomous vehicle 100b.

In addition, the robot 100a interacting with the autonomous vehicle 100b may provide information to the autonomous vehicle 100b or assist the function at the outside of the autonomous vehicle 100b. For example, the robot 100a may provide traffic information including traffic sign information to the autonomous vehicle 100b like a smart traffic light or may automatically connect an electric charger to the charging port by interacting with the autonomous vehicle 100b like an automatic electric charger of the electric vehicle.

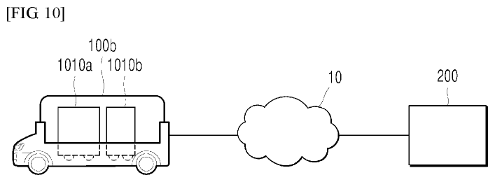

FIG. 10 is an exemplary diagram of an autonomous vehicle loaded with service modules 1010a and 1010b according to one embodiment of the present disclosure and a driving operation control environment. Hereinafter, a description of the common parts previously described with reference to FIGS. 1 to 9 will be omitted. Referring to FIG. 10, the autonomous vehicle and driving operation control environment according to one embodiment may include an autonomous vehicle 100b loaded with service modules 1010a and 1010b, a machine learning based AI server device 200, and a network 10 which is configured by 5G communication or other communication method to connect the above components.

The autonomous vehicle 100b may transmit or receive information between various devices in the autonomous vehicle 100b such as a processor 180 and a sensor 140, through a network (not illustrated) in the autonomous vehicle 100b as well as a network 10 which can communicate with the AI server device 200.

The internal network of the autonomous vehicle 100b may use a wired or wireless manner. For example, the internal network of the autonomous vehicle 100b may include at least one of controller area network (CAN), universal serial bus (USB), a high definition multimedia interface (HDMI), recommended standard d232 (RS-232), or a plain old telephone service (POTS), an universal asynchronous receiver/transmitter (UART), a local interconnect network (LIN), media oriented systems transport (MOST), Ethernet, FlexRay, and Wi-Fi based network.

The internal network of the autonomous vehicle 100b may include at least one of telecommunications network, for example, computer networks (for example, LAN or WAN).

According to one embodiment, the autonomous vehicle 100b may receive map information, a driving route, traffic information, or a learning model trained in the AI server device 200 (to recognize objects from sensor data or determine a corresponding driving operation in accordance with the recognized environment) from the AI server device 200 through the network 10. The driving route received from the AI server device 200 may be a driving route to move the loaded service modules 1010a and 1010b to a client vehicle or a delivery location and may be modified by the autonomous vehicle 100b based on the map information and the traffic information.

According to one embodiment, the autonomous vehicle 100b may be an autonomous vehicle 100b for movement which moves the service modules 1010a and 1010b to the client vehicle or a delivery location or an autonomous vehicle 100b for a service which controls the service modules 1010a and 1010b and supplies power to the service modules 1010a and 1010b to provide a service or a service article to the client through the service modules 1010a and 1010b, while moving or in a fixed location.

According to one embodiment, the autonomous vehicle 100b for movement may deliver the loaded service modules 1010a and 1010b to the other autonomous vehicle 100b for movement or an autonomous vehicle 100b for a service. The autonomous vehicle 100b for a service is loaded with the service modules 1010a and 1010b or disposes the service modules 1010a and 1010b at the outside to provide a service or a service article to the client through the service modules 1010a and 1010b. For example, when the autonomous vehicle 100b for a service provides foods as a service article, the autonomous vehicle 100b for a service provides the food made in the service module to the client vehicle on the move which requests the article while proximately driving or in a parked state.

According to one embodiment, the autonomous vehicle 100b may include a loader which loads the service modules 1010a and 1010b for the purpose of movement or the service. When the service modules 1010a and 1010b are loaded in the autonomous vehicle 100b for movement or the autonomous vehicle 100b for a service, the service modules 1010a and 1010b may include a power reception module through which the power is supplied. The autonomous vehicle 100b may include a power supply connector (not illustrated) to supply the power to the service modules 1010a and 1010b. In this case, the controller of the autonomous vehicle 100b for movement or the autonomous vehicle 100b for a service communicates with the service modules 1010a and 1010b to sense an electric energy required to maintain the service modules 1010a and 1010b or provide a service, in order to supply the power to the service modules 1010a and 1010b.

According to one embodiment, the service modules 1010a and 1010b may be independent devices from the autonomous vehicle 100b to provide a service to the client or manufacture a service article. For example, the service modules 1010a and 1010b may be a device which automatically makes beverages or a device which allows a service worker to make beverages using the service modules 1010a and 1010b. For example, the service modules 1010a and 1010b may be a sound device which amplifies sound data received from the other device or a relaxation service device which provides relaxation to the client. As long as a device provides a service or manufactures a service article, a type of the service modules 1010a and 1010b is not specifically limited.

According to one embodiment, the service modules 1010a and 1010b may include a communicator (not illustrated), a driving unit (not illustrated), a moving unit (not illustrated), and a controller (not illustrated) which may be movable separately from the autonomous vehicle 100b. For example, the service modules 1010a and 1010b may include a battery for supplying the power to the driving unit and the moving unit and a processor for controlling wheels for movement, a motor for driving, and the driving unit. Therefore, the service modules 1010a and 1010b may move by changing the location or change the direction in accordance with indication of the autonomous vehicle 100b for movement or the autonomous vehicle 100b for a service or indication of a controller or self-determination. In this case, the autonomous vehicle 100b for a service selects a position to dispose the service modules 1010a and 1010b in accordance with service contents or service articles provided by the service modules 1010a and 1010b and the controller of the autonomous vehicle 100b for a service may transmit a position to the service modules 1010a and 1010b to be moved.

According to one embodiment, not only when the service modules 1010a and 1010b are disposed at the outside of the autonomous vehicle 100b, but also when the service modules 100a and 100b are loaded in the loader of the autonomous vehicle 100b for a service or the autonomous vehicle 100b for movement, the service modules 1010a and 1010b may move or change the direction by changing the location in accordance with indication of the autonomous vehicle 100b, indication of the controller, or self-determination. For example, when the service modules 1010a and 1010b are loaded in the loader of the autonomous vehicle 100b for movement and the autonomous vehicle 100b for movement is on the move, if the service modules 1010a and 1010b receive a movement command through the communication of the autonomous vehicle 100b for movement, the service modules 1010a and 1010b may be moved in the loader to change a loading position in accordance the movement command of the autonomous vehicle 100b for movement, which will be described in more detail below.

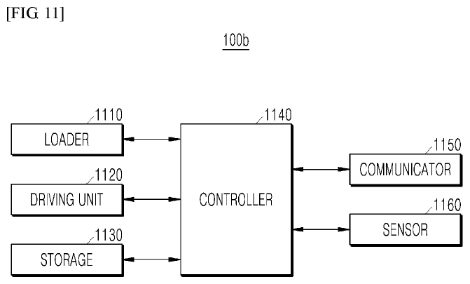

FIG. 11 illustrates a component of the autonomous vehicle 100b according to one embodiment of the present disclosure in which the AI device 100 of FIG. 7 is implemented as the autonomous vehicle 100b of FIG. 9. Hereinafter, a description of the common parts previously described with reference to FIGS. 1 to 10 will be omitted.

Referring to FIG. 11, the autonomous vehicle 100b according to one embodiment includes a loader 1110 which loads the service modules 1010a and 1010b to move the service modules 1010a and 1010b or provide a service through the service modules 1010a and 1010b, a driving unit 1120 which drives the autonomous vehicle 100b, a storage 1130 which stores a driving route, traffic information and a learning module received from the AI server device 200 and stores commands to control the driving unit 1120, a controller 1140 which controls not only the loader 1110 and the driving unit 1120, but also the position movement of the service modules 1010a and 1010b, a communicator 1150 which transmits a position movement command to the service module 1010a and 1010b, selectively receives module information from the service modules 1010a and 1010b, and supports communication between internal devices of the autonomous vehicle 100b, and a sensor 1160 which monitors an external environment in the autonomous vehicle 100b.

According to one embodiment, the loader 1110 of the autonomous vehicle 100b may include a space for loading the service modules 1010a and 1010b and a space for mounting the sensor 1160 for monitoring a weight of the service modules 1010a and 1010b loaded in the space or a number of vibrations of the service modules 1010a and 1010b while driving the autonomous vehicle 100b.

According to another embodiment, the loader 1110 may include a delivering unit (not illustrated) to deliver a service article requested by the client vehicle to the client vehicle which is driving or parked, a sensor (for example, a distance sensor such as a lidar or an ultrasonic sensor or a camera) to align the delivering unit with the product receiver of the client vehicle for receiving the product, and a mechanical unit (a motor for driving a belt to deliver the service article) which expands the delivering unit.

According to one embodiment, the driving unit 1120 of the autonomous vehicle 100b may include sub driving units such as a power train driver (not illustrated, a power source or a transmission driver) for a driving operation and safe driver, a chassis driver (not illustrated) (steering, break, or suspension driver), and a safety device driver (not illustrated) (an air bag or seat belt driver). The driving unit 1120 controls the sub driving units in accordance with the command of the controller 1140 to move the autonomous vehicle 100b or operates sub driving units required for driving.

According to one embodiment, the storage 1130 of the autonomous vehicle 100b temporally or non-temporally stores commands for controlling the driving unit 1120, one more commands which configure the learning model, parameter information which configure the learning model, driving route information and traffic information received from the AI server device 200, data of the sensor 1160, and the like.

According to one embodiment, the controller 1140 of the autonomous vehicle 100b controls the driving unit 1120 to drive, stop, or move the autonomous vehicle 100b and the driving of the autonomous vehicle 100b may include acceleration driving, deceleration driving, turning, and stopping of driving. The controller may include a module configured by hardware or software including at least one processor. The controller 1140 controls the driving unit 1120 of the autonomous vehicle 100b in accordance with a driving route received from the AI server device 200 or a driving route determined by the autonomous vehicle 100b in accordance with the traffic information received from the AI server device 200 to control a speed and a driving operation of the autonomous vehicle 100b.

According to one embodiment, the controller 1140 controls the driving operation of the autonomous vehicle 100b based on the driving route and the module information of the autonomous vehicle 100b. The driving route is determined by the AI server device 200 by reflecting a traffic condition in accordance with a departure point and a destination of the autonomous vehicle 100b and then transmitted to the autonomous vehicle 100b or determined by the autonomous vehicle 100b by reflecting the traffic condition.

According to one embodiment, the different driving routes may be set depending on the module information. For example, when the service modules 1010a and 1010b loaded in the autonomous vehicle 100b is sensitive to shock or the number of vibrations of the service modules 1010a and 1010b is high depending on the weight, the AI server device 200 or the autonomous vehicle 100b may set a route passing through a highway or paved roads only as the driving route to the destination and changes the driving route in accordance with the traffic condition during driving and the situation (for example, the increased number of vibrations in accordance with the road condition) of the service modules 1010a and 1010b monitored during driving. The controller 1140 may control the driving operation to drive the autonomous vehicle 100b based on the determined driving route.

According to another embodiment, the controller 1140 determines different driving operations depending on the module information and controls the driving unit 1120 in accordance with the determined driving operation. For example, when a weight of the service modules 1010a and 1010b loaded in the loader 1110 is light so that there is a risk of falling at the time of turning, accelerating, or decelerating, the controller 1140 determines a turning speed, an acceleration, or a deceleration in consideration of the weight and controls the driving unit 1120. Further, when the number of vibrations of the service modules 1010a and 1010b is increased during driving, the controller may control the driving unit 1120 to lower the speed.

According to one embodiment, the module information may include service type information (for example, entertainment, food and beverage making, and relaxation) in accordance with a provided service, module weight information (including information on a center of mass), module size information, shock sensitivity information of module (for example, a possibility of trouble or erroneous operation of module with respect to external shock or a maximum shock margin), risk information of a module (for example, explosion or risk of the module due to external shock), information about food and beverage materials included in the module, and dangerous article loading information of a module (for example, whether to load hydrogen gas, carbonic gas, or LPG gas). The contents of the corresponding information may be transmitted or received as a formal code readable using a look-up table or sensed by the sensor.

According to one embodiment, the sensor 1160 of the autonomous vehicle 100b may include an optical camera, a radar, a lidar, an ultrasonic sensor, or an infrared sensor. The sensor 1160 may include a gyro sensor, an acceleration sensor, a weight sensor, a geomagnetic sensor, a pressure sensor, and a vibration sensor (a shock sensing sensor). The weight sensor is mounted in the loader in which the service modules 1010a and 1010b are loaded to sense a weight change of at least one loaded service modules 1010a and 1010b. Some of the pressure sensor, the vibration sensor, and the acceleration sensor are mounted in a plurality of locations of the loader to sense the number of vibrations of at least one of the service modules 1010a and 1010b in accordance with the vibration of the autonomous vehicle 100b during driving.

Further, the sensor 1160 may include an internal/external illumination sensor, a rainfall sensor, a temperature sensor, a shock sensor, a proximity sensor, a water temperature sensor (WTS), a throttle position sensor (TPS), an idle switch, a TDC sensor, an AFS sensor, a pressure sensor, an inertial sensor, a position sensor, a speed sensor, a level sensor, a gyro sensor, and a tilt sensor, and also include sensors utilized in the vehicle in the related art, but a type is not specifically limited.

The autonomous vehicle 100b according to one embodiment of the present disclosure may further include a communicator 1150 which transmits or receives information with the AI server device 200 based on a configured grant or transmits or receives information with the service modules 1010a and 1010b and receive module information through the communicator 1150. For example, the controller 1140 may configure a communication channel with an proximate service modules 1010a and 1010b through the communicator 1150 after or before loading the service modules 1010a and 1010b, request module information including at least one of unique identifier UID of the service modules 1010a and 1010b, service type information, module weight information, module size information, shock sensitivity information of the module, risk information of the module, information about food and beverage materials included in the module, and dangerous article loading information of the module through the corresponding communication channel, and receive a response thereto from the service modules 1010a and 1010b. As another example, after inquiring the service modules 1010a and 1010b for the unique identifier, the controller receives module information of service modules 1010a and 1010b which will be loaded or have been loaded, through the received UID, from the AI server device 200 based on the downlink grant. The controller may receive module information of the service modules 1010a and 1010b to be loaded from the AI server device 200 based on the downlink grant.

According to one embodiment, the controller 1140 may control the driving unit 1120 to perform driving operation based on any one of the service type information, the module weight information, the module size information, the shock sensitivity information of the module, the risk information of the module, information about food and beverage materials included in the module, and dangerous article loading information of the module and a scheduled driving route. For example, when the scheduled driving route is a turning sector and information about food and beverage materials included in the specific service modules 1010a and 1010b or size or weight information are considered, if the autonomous vehicle performs a turning operation at an angular velocity of 20 degrees or larger per second in the turning sector, the corresponding service modules 1010a and 1010b may fall or the food or beverages may overflow. In this case, the controller may control the driving unit 1120 to perform the turning operation at an angular velocity of 20 degrees or less per second.

The autonomous vehicle 100b according to one embodiment of the present disclosure may include the sensor 1160 which is mounted in the loader to monitor the weight of the service modules 1010a and 1010b, the number of vibrations during driving, a position in the loader during driving, an interval between the plurality of service modules 1010a and 1010b during driving.

According to one embodiment, the controller 1140 may consider at least one of the service type information, the module weight information, the module size information, the shock sensitivity information of the module, the risk information of the module, the information about food and beverage materials included in the module, and the dangerous article loading information of the module of the module information received from the AI server device 200 based on the downlink grant and control the driving unit based on any one of the weight, the number of vibrations, and the location of the service modules 1010a and 1010b which are monitored by the sensor 1160 during driving and a scheduled driving route. For example, when the number of vibrations of specific service modules 1010a and 1010b in accordance with the driving of the autonomous vehicle 1010b from the sensor 1160 mounted in the loader 1110 is increased, the controller 1140 may control the driving unit 1120 to reduce the speed. As another example, when the number of vibrations of the specific service modules 1010a and 1010b in accordance with the driving of the autonomous vehicle 100b from the sensor 1160 is close to a limit of the number of vibrations which is calculated in advance in accordance with the weight of the service modules 1010a and 1010b included in the module information received from the AI server device 200 based on the downlink grant, the controller 1140 may control the driving unit 1120 to reduce the speed. As another example, when the weight in accordance with the turning of the specific service modules 1010a and 1010b sensed by the sensor 1160 mounted in the loader 1110 is close to a predetermined limit to be reduced due to the rotation, the driving unit 1120 may be controlled to reduce a rotation (angular) velocity to prevent the falling due to the rotation.

The autonomous vehicle 100b according to one embodiment of the present disclosure further includes a communicator 1150 which transmits and receive information with the service modules 1010a and 1010b and transmits a movement command to the service modules 1010a and 1010b through the communicator 1150 to move to a specific position. For example, when an expected driving operation (for example, the turning, the acceleration driving, or the deceleration driving) is performed along the driving route which is received from the AI server device 200 based on the configured grant or determined by the autonomous vehicle 100b, if the falling of the service modules 1010a and 1010b or the collision between the service modules 1010a and 1010b is expected, the controller 1140 may calculate the positions of the respective service modules 1010a and 1010b to prevent the falling or the collision. In this case, the controller 1140 may transmit a movement command to at least one of the service modules 1010a and 1010b to move to a calculated position.

According to one embodiment, the controller 1140 may calculate a position where the service modules 1010a and 1010b need to move, based on the module information received from the AI server device 200 based on the configured grant or received from the service modules 1010a and 1010b. For example, when the falling of the service modules 1010a and 1010b is expected at an acceleration driving of 20 km/h which is a driving operation expected in consideration of weight information of the service modules 1010a and 1010b included in the module information, the service modules 1010a and 1010b may be moved to the driving direction simultaneously with the acceleration driving.

The controller 1140 of the autonomous vehicle 100b according to one embodiment of the present disclosure performs the acceleration driving or the deceleration driving which are expected driving operations along the driving route received from the AI server device 200 based on the configured grant or determined by the autonomous device 100b, in order to prevent the expected falling of the service modules 1010a and 1010b or collisions between the service modules 1010a and 1010b, the autonomous vehicle may perform alternately acceleration driving at different accelerations (including a negative acceleration or 0) to reach a target speed. The acceleration includes a negative acceleration. For example, when a highest acceleration which can prevent the falling in consideration of the weight of the service modules 1010a and 1010b and the center of mass is 20 km/h and acceleration of 50 km/h is required to reach a target speed, the autonomous vehicle 100b may control the driving unit 1120 to accelerate at an acceleration of 20 km/h for a predetermined time period at which the acceleration driving starts, at an acceleration of 10 km/h for a next time period, and at an acceleration of 20 km/h again for a next time period to reach the target speed. Alternatively, the autonomous vehicle 100b controls the driving unit 1120 to accelerate at an acceleration of 20 km/h for a predetermined time period, at a constant velocity (acceleration of 0) for a next time period, and at an acceleration of 20 km/h again for a next time period to reach the target speed.

According to one embodiment, when the deceleration driving or the acceleration driving is necessary, the number of changes of acceleration and a magnitude of the acceleration may be determined in consideration of a distance from a preceding vehicle. For example, when the service modules 1010a and 1010b are not loaded, if it is expected that it takes 10 seconds to stop from the start of the deceleration driving in consideration of the distance from the preceding vehicle which stops, it takes 15 seconds to alternately perform the deceleration driving at two different accelerations for the same distance from the same preceding vehicle depending on the module information of the loaded service modules 1010a and 1010b. Therefore, the controller 1140 starts the acceleration driving or the deceleration driving in consideration of the module information of the service modules 1010a and 1010b and the distance from the preceding vehicle and determines the number of changes of acceleration and a magnitude of the acceleration to the target speed.

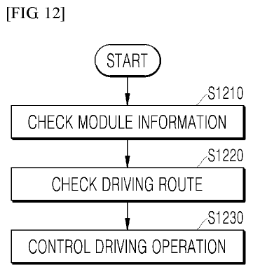

FIG. 12 is a flowchart for explaining an operation of an autonomous vehicle 100b according to one embodiment of the present disclosure. Hereinafter, a description of the common parts previously described with reference to FIGS. 1 to 11 will be omitted.

Referring to FIG. 12, the autonomous vehicle 100b may check module information of a loaded module in step S1210.

According to one embodiment, the module information may be received from the AI server device 200 based on the configured grant or from the loaded service modules 1010a and 1010b. For example, the autonomous vehicle 100b requests module information including at least one of unique identifier UID of the service modules 1010a and 1010b, service type information, module weight information, module size information, shock sensitivity information of the module, risk information of the module, information about food and beverage materials included in the module, and dangerous article loading information of the module through the communication channel with the service module 1010a and 1010b and receives a response thereto from the service modules 1010a and 1010b. As another example, after inquiring the service modules 1010a and 1010b for the unique identifier, the controller receives module information of service modules 1010a and 1010b which will be loaded or have been loaded, through the received UID, from the AI server device 200 based on the downlink grant. Further, the controller may receive module information of the service modules 1010a and 1010b to be loaded from the AI server device 200 based on the downlink grant.

According to another embodiment, the module information may be measured by the sensor 1160 which is mounted in the loader 1110 to monitor the weight of the service modules 1010a and 1010b, the number of vibrations during driving, a position in the loader during driving, an interval between the plurality of service modules 1010a and 1010b during driving.

In step S1220, the autonomous vehicle 100b may check the driving route received from the AI server device 200 based on the configured grant or determined by the autonomous vehicle 100b based on stored map information. The driving route may be changed in accordance with traffic information received based on the downlink grant to be received or re-determined.

In step S1230, the autonomous vehicle 100b may control the driving operation of the autonomous vehicle 100b based on the determined or received driving route and the received or sensed module information.

According to one embodiment, when the risk such as damage or explosion of the service modules 1010a and 1010b or falling or collision of the service modules 1010a and 1010b are expected in consideration of the driving operation (the turning, the acceleration driving, or the deceleration driving) expected in accordance with the driving route and the module information of the service modules 1010a and 1010b, the autonomous vehicle 100b may control the driving operation to prevent the risk, the falling, or the collision. For example, as compared with an example that the service modules 1010a and 1010b are not loaded, the driving operation may be controlled to drive by changing the turning acceleration, the acceleration (including a negative acceleration or 0) of the acceleration driving or the deceleration driving.

According to one embodiment, the autonomous vehicle 100b may control the driving operation in consideration of at least one of the type, the size, and the weight of the service module and the driving route. For example, the type of the module may be extracted from service type information (for example, entertainment, food and beverage making, or relaxation) according to a service provided by the service modules 1010a and 1010b, the weight of the service module may be extracted from the weight information (including information on center of mass) of the module information, and the size of the service module may be extracted from the size information (a width, a length, a height, etc.) of the module information.

According to one embodiment, when the autonomous vehicle 100b performs a driving operation along the driving route expected in consideration of at least one of the type, the size, and the weight of the service module, if the risk of damage or explosion of the service module 1010a and 1010b or the falling or collision of the service modules 1010a and 1010b, the autonomous vehicle 100b may control the driving operation to prevent the risk, the falling, or the collision. Therefore, the risk, falling, or collision possibility in accordance with an expected driving operation may be differently calculated from the type, the size, and the weight of the service module and this the driving operation to be controlled may also be different.

According to one embodiment, when the number of vibrations of the loaded service modules 1010a and 1010b is close to a set criteria due to the driving of the autonomous vehicle 100b in a space where the service modules 1010a and 1010b are loaded or the increased speed exceeds a set criteria, the autonomous vehicle 100b may set a route passing through a highway or paved roads only as the driving route to the destination and control the driving operation to drive along the changed driving route.

According to another embodiment, when the number of vibrations of the service modules 1010a and 1010b is close to the set criteria or the increasing speed exceeds the set criteria, the autonomous vehicle 100b controls the driving operation to reduce the speed or control the driving operation to lower the acceleration or a maximum limit value of the acceleration.

One embodiment in which the autonomous vehicle 100b controls the decelerating operation among the driving operations based on the module information and the driving route will be described with reference to FIG. 13.

According to one embodiment, when the deceleration driving is necessary, the number of changes of acceleration and a magnitude of the acceleration may be determined in consideration of a distance from a preceding vehicle. For example, when the service modules 1010a and 1010b are not loaded, it is expected to take 10 seconds to stop from the start of the deceleration driving in consideration of the distance from the stopped preceding vehicle so that it is sufficient to start the deceleration driving at a point P3 as illustrated in FIG. 13A. However, when the service modules 1010a and 1010b are loaded, it may take longer time to stop from starting the deceleration driving in consideration of the risk or falling even though in the same distance from the preceding vehicle depending on the module information of the loaded service modules 1010a and 1010b. This is because the deceleration driving is alternately performed at different accelerations to stop from the start of the deceleration driving. In this case, when the service modules 1010a and 1010b are not loaded, the autonomous vehicle 100b may control the driving operation to start the deceleration driving in a position (P2 of FIG. 13B) earlier than the point P3 at which the deceleration driving starts. Further, in consideration of the module information of the service modules 1010a and 1010b and the distance from the preceding vehicle, the number of changes of (negative) acceleration and a magnitude of the (negative) acceleration to stopping after starting the deceleration driving or the target speed may be determined.

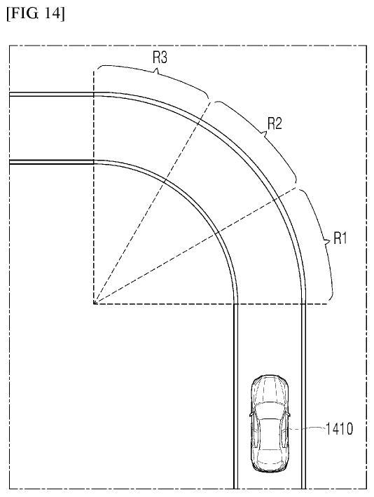

One embodiment in which the autonomous vehicles 100b and 1410 control the turning operation among the driving operations based on the module information and the driving route will be described with reference to FIG. 14.

According to one embodiment, when the turning is necessary along the expected driving route and there is a possibility of falling of the service modules 1010a and 1010b at the time of turning, the autonomous vehicles 100b and 1410 divides the turning route into a plurality of sector and controls the driving operation to drive the divided driving routes by different driving operations. For example, referring to FIG. 14, the expected turning route is divided into R1, R2, and R3 and when the autonomous vehicle performs the turning operation at a turning angular velocity of the normal autonomous vehicles 100b and 1410, the falling of the service modules 1010a and 1010b may be expected. In this case, the autonomous vehicle 100b and 1410 may control the driving operation to drive at different turning angular velocities in at least two sections among R1, R2, and R3 and the number of divided routes of the turning routes or the turning angular velocity of each of the divided turning routes may be determined based on the module information to prevent the risk or the falling of the service modules 1010a and 1010b.

According to one embodiment, when the autonomous vehicle 100b controls the driving operation to drive the divided routes of the turning routes at different turning angular velocity, a warning message (V2V message or V2X message) may be transmitted or broadcasted to prevent the entering into the turning route to allow the other vehicles to drive by predicting and referring to the operation of the autonomous vehicle 100b.

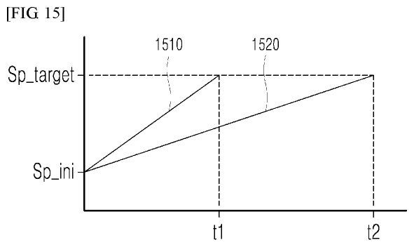

One embodiment in which the autonomous vehicle 100b controls the accelerating operation among the driving operations based on the module information and the driving route will be described with reference to FIG. 15.

According to one embodiment, when a driving operation expected in accordance with the driving route which is received from the AI server device 200 based on the configured grant or determined in the autonomous vehicle 100b is the acceleration driving and a target speed is determined, the magnitude of the acceleration may be determined in consideration of the module information. For example, referring to FIG. 15, when a target speed is Sp_target and a current speed is Sp_ini, the autonomous vehicle 100b accelerates at an acceleration (1510) to reach the target speed Sp_target at a timing t1 from the acceleration driving starting timing. However, there is a possibility of falling of the service modules 1010a and 1010b when the acceleration driving is performed at the corresponding acceleration (1510), the driving operation may be controlled to reach the target speed Sp_target at a timing t2 at a lower acceleration (1520) to prevent the falling.

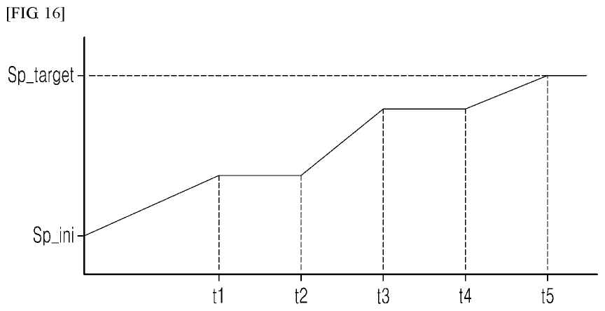

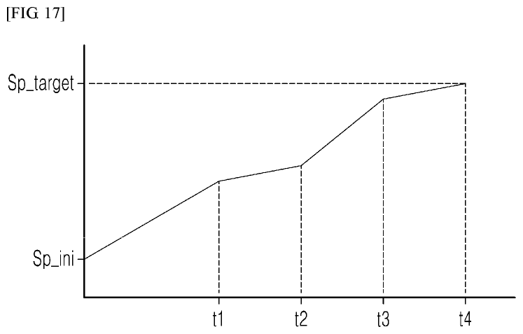

Another embodiment in which the autonomous vehicle 100b controls the accelerating operation among the driving operations based on the module information and the driving route will be described with reference to FIGS. 16 and 17.

According to one embodiment, when a driving operation expected in accordance with the driving route which is received from the AI server device 200 based on the configured grant or determined in the autonomous vehicle 100b is the acceleration driving and a target speed is determined, the autonomous vehicle 100b divides the driving routes to reach the target speed to control the driving operation to drive on the divided driving routes by different driving operations. For example, a target speed is Sp_target and the current speed is Sp_ini, the autonomous vehicle 100b may control the driving operation to accelerate at different accelerations (including acceleration of 0) on at least two driving routes of driving routes at the timings t1, t2, t3, t4, and t5 of FIG. 16 and driving routes at the timings t1, t2, t3, and t4 of FIG. 17, respectively.

Referring to FIG. 16, the acceleration driving and the constant velocity driving are alternately performed on the driving routes at the timings t1, t2, t3, t4, and t5 to reach the target speed Sp_target and referring to FIG. 17, the driving is alternately performed at different accelerations which is not 0 on the driving routes at the timings t1, t2, t3, and t4 to reach the target speed Sp_target.

According to one embodiment of the autonomous vehicle 100b according to the present disclosure, the autonomous vehicle 100b may transmit a movement command to the service modules 1010a and 1010b to move to a specific position. For example, when an expected driving operation (for example, the turning, the acceleration driving, or the deceleration driving) is performed along the driving route which is received from the AI server device 200 based on the downlink grant or determined by the autonomous vehicle 100b, if the falling of the service modules 1010a and 1010b or the collision between the service modules 1010a and 1010b is expected, the positions of the service modules 1010a and 1010b for preventing the falling or the collision is calculated and a movement command is transmitted to at least one of the service modules 1010a and 1010b to move to the calculated position. For example, when the falling of the service modules 1010a and 1010b is expected during the acceleration driving of 20 km/h which is a driving operation expected in consideration of weight information of the service modules 1010a and 1010b included in the module information, the service modules 1010a and 1010b may be moved to the driving direction simultaneously with the acceleration driving.

According to one embodiment of the autonomous vehicle 100b according to the present disclosure, the autonomous vehicle 100b may control the driving operation based on service type information (for example, entertainment, food and beverage making, or relaxation) among module information or a type of a service article.

For example, when the expected driving route is a turning sector and food and beverage information of the service type of the specific service modules 1010a and 1010b is related to the providing of the food and beverage service article, or a client vehicle which is driving requests a service article related the food and beverage, the service modules 1010a and 1010b are likely to fall or food or beverages to be delivered to the client vehicle are likely to fall or overflow. In this case, the autonomous vehicle 100b may transmit a message (V2V message) for requesting the change of the route or the speed to the client vehicle to deliver the service article to the client vehicle while preventing the falling.

1. A driving control method of an autonomous vehicle, comprising:
checking module information of a loaded service module;
checking a driving route; and
controlling a driving operation of a vehicle based on the driving route and the module information.

2. The driving control method according to claim 1, wherein the checking of module information includes receiving information related to at least one of a type, a size, and a weight of the service module from the service module or from a server based on a downlink grant, and
in the controlling of a driving operation, the driving operation is controlled based on at least one of the type, the size, and the weight of the service module and the driving route.

3. The driving control method according to claim 1, wherein the checking of module information includes checking a weight of the service module or a number of vibrations during driving through a sensor of a loader in which the service module is loaded, and
in the controlling of a driving operation, the driving operation is controlled based on the driving route and any one of the weight of the service module and the number of vibrations during driving.

4. The driving control method according to claim 3, wherein the controlling of a driving operation includes controlling at least one of a maximum limit value of a driving speed, a maximum limit value of a driving acceleration and the driving speed to be lowered when a magnitude or variation of the number of vibrations exceeds a set criteria.

5. The driving control method according to claim 3, wherein the controlling of a driving operation includes controlling the driving operation based on a possibility of a fall of the service module.

6. The driving control method according to claim 5, wherein the controlling of a driving operation includes controlling the driving operation to perform turning in different curved sections of a curved route at different angular velocities when the turning is necessary for the curved route of the driving route.

7. The driving control method according to claim 6, further comprising:
after the controlling of a driving operation, transmitting a warning message to surrounding vehicles to prevent the surrounding vehicles from entering a turning route.

8. The driving control method according to claim 5, wherein the controlling of a driving operation includes controlling the driving operation by driving in different sections of the driving route at different accelerations to reach a target speed if deceleration driving or acceleration driving is necessary in the driving route.

9. The driving control method according to claim 8, wherein the controlling of a driving operation includes controlling the driving operation by driving in different sections of the driving route alternately at acceleration and at a constant velocity to reach the target speed.

10. The driving control method according to claim 3, further comprising:
transmitting a module movement command to the service module to prevent a fall or collision of the service module based on the driving operation expected in accordance with the driving route.

11. The driving control method according to claim 1, wherein during the controlling of a driving operation, the driving operation is controlled based on the type of service articles provided by the service module, and
the driving control method of an autonomous vehicle further includes:
requesting a client vehicle to change a route or a speed in order to deliver a service article to the client vehicle.

12. A computer-readable recording medium in which a program which executes the method according to claim 1 using a computer is stored.

13. An autonomous vehicle, comprising:
a loader which loads a service module;
a driving unit which moves an autonomous vehicle; and
a controller which controls the driving unit to perform at least one of acceleration driving, turning, and stopping of the autonomous vehicle,
wherein the controller checks a driving route of an autonomous vehicle and module information of the service module and controls the driving unit based on the driving route and the module information.

14. The autonomous vehicle according to claim 13, further comprising:
a communicator which transmits/receives information with the service module or transmits/receives information with a server device based on a configured grant,
wherein the controller receives the module information including information related to at least one of a type, a size, and a weight of the service module through the communicator, and the controller controls the driving unit based on at least one of the type, the size, and the weight of the service module and the driving route.

15. The autonomous vehicle according to claim 13, further comprising:
a sensor which is mounted in the loader to sense a weight of the service module or a number of vibrations during driving,
wherein the controller controls the driving unit based on the driving route and any one of the weight of the service module and the number of vibrations during driving.

16. The autonomous vehicle according to claim 13, further comprising:
a communicator which transmits/receives information with the service module,
wherein the controller calculates, based on a driving operation expected in accordance with the driving route, a position of the service module for preventing a fall or collision of the service module, and
the communicator transmits a movement command to the service module to move to the position of the service module.

17. The autonomous vehicle according to claim 13, wherein when deceleration driving or acceleration driving is necessary, the controller controls to alternately drive at different accelerations to reach a target speed.

18. The autonomous vehicle according to claim 17, further comprising:
a distance sensor which measures a distance from a preceding vehicle,
wherein the controller determines a number of changes of acceleration and a magnitude of the acceleration based on the distance from the preceding vehicle.

19. A computer-readable recording medium in which a program which executes the method according to claim 2 using a computer is stored.

20. A computer-readable recording medium in which a program which executes the method according to claim 3 using a computer is stored.
